(19) United States
(12) Patent Application Publication
(10) Pub. No.: US 2012/0276838 A1
(43) Pub. Date: Nov. 1, 2012

(54) Radio frequency signal detection and replication apparatus and method

(76) Inventor: Brian Edwards, El Paso, TX (US)

(21) Appl. No.: 12/313,331

(22) Filed: Nov. 19, 2008

Related U.S. Application Data
(60) Provisional application No. 61/003,947, filed on Nov. 21, 2007.

(51) Int. Cl. H04K 3/00

(52) U.S. Cl. 455/1

(57) ABSTRACT

An apparatus and system for the replication of a Radio Frequency (RF) signal that is being employed as a method of activating or functioning a Radio Controlled Improvised Explosive Device (RCIED), which comprises the method of scanning the RF spectrum, detecting a signal, replicating any embedded coding contained within the signal and transmitting the signal in a repetitious state while periodically scanning the RF spectrum for the same signal or another signal that meets the programmed replication criteria.

### BACKGROUND OF THE INVENTION

1. Field of the Invention

This invention relates to an apparatus and method for detecting and replicating radio frequencies in connection with Improvised Explosive Devices.

2. Description of the Prior Art

Military forces currently engaged on the modern battlefield are faced with one of the most nefarious weapons known; the Improvised Explosive Device (“IED”). One type of IED is one which is radio controlled (“RCIED”). The RCIED comes in all shapes and sizes but what makes it unique to the other IEDs encountered on the battlefield is that it can be armed (fully functional and ready to detonate), disarmed or detonated by a number of methods involving wireless remote controls such as garage door openers, key fobs, cell phones, and cordless telephones. These actions can occur while the triggerman is blending in with the local population several kilometers away from the RCIED, making it very difficult for military or law enforcement to identify the responsible parties.

The current technology, such as that described in U.S. Pat. No. 4,891,646, for Modulated Single Channel Radio Frequency Memory, U.S. Patent Application US 2006/0060074, for Radio Frequency Jammer; U.S. Patent Application Publication US 2006/0164283 A1, for Method, System and Apparatus for Maximizing a Jammer's Time-on-Target and Power-on-Target; U.S. Patent Application Publication US 2006/0240790 A1, for Wireless Transmitter; U.S. Patent Application Publication US 2006/0267827 A1, for Optimized Utilization of Electronic Counter Measures; and U.S. Patent Application Publication US 2007/0063886 A1, for System and Method for Suppressing Radio Frequency Transmissions, is to combat the RCIED through Electronic Counter-Measures (ECM) or Jammers. These systems work by identifying any electronic signal that is present in the vicinity and broadcasting electronic ‘static’ or ‘white noise’ on the frequency that the signal exists thereby disrupting communication between a transmitter and a receiver. The jamming of transmitted signals is designed to disrupt command signals before the signal is received by the designated receiver.

The basis for the afore mentioned systems is to either a) transmit electronic ‘static’ or ‘white noise’ across either a broad spectrum of radio frequencies, or b) scan the RF frequencies and upon detection of any signal, transmit electronic ‘static’ in an effort to overpower the original signal. Regardless of which method is utilized, the common factor is the application of high-power energy in the RF spectrum. This is, in part, a contradiction to the methodology employed by the invention disclosed herein. An analogy that can be applied is a discussion is between two persons. One person is talking and the other is listening. The listener is controlling a light switch. When the speaker commands the lights to be on or off the listener responds to the commands. Enter a third person who begins making loud noises. The intent of this action is not to disrupt the speaker but to interfere with the person who is listening to the speaker. The listener can not receive commands because of the interference of the third person.

With current jamming technology, the disrupted signal could be as simple as a low to high or high to low change state, commonly referred to as On-Off Keying (OOK), or the more technically correct terms Amplitude Shift Keying (ASK), Frequency Shift Keying (FSK) or Pulse Modulation. This is analogous to a single channel remote control toy model or a purpose-built circuit that utilizes multiple bits of information within a Programmable Integrated Circuit (PIC), that is translated into an arming/disarming or detonate command. Regardless of the form in which that RF signal is presented, current ECM technology is restricted by the fact that in order to successfully block a receiver from receiving the intended signal the ECM system must have a relatively large power output in order to ‘blind’ the receiver from the signal. Power requirements are more constricted when an ECM system is ‘jamming’ a wide bandwidth or several narrow bandwidths on different frequencies.

The Achilles heel of current ECM systems is that the radio frequency interference that is emanated by the Jammers can be used against itself. RCIEDs can be designed; built and employed that utilizes the disruption of a continuous RF signal to cause an IED to either arm or immediately detonate when the signal is disrupted. In the ‘armed’ state the actual firing signal can come from various methods currently in use in IED construction. Purpose specific and built circuits designed to become ‘active’ upon the loss of a specific signal can be produced by a person knowledgeable in the art of electronics. However, a person with limited knowledge in the application of circuit design but with a greater understanding of how circuits work can modify existing circuits to function upon the loss of a signal. The largest sources for circuits with this potential are the multitude of general stores and specialty model hobby stores, catalogs and websites.

Contemporary radio controlled toys (“RC”) operate via radio transmitted signals in the FM band; currently restricted in the United States by the FCC to 27 megahertz (MHz) and 49 MHz. Transmitted signals contain a synchronization sequence and a burst sequence. The synchronization sequence identifies the properly programmed receiver that it is about to receive information. The information sequence that follows the synchronization sequence tells the toy what function to do such as turn left, stop or go forward. As a continuation of the listener analogy, the listener who controls the light switch will hold the light switch in the off position so long as the first person repeatedly tells the listener to keep the lights off. If the person speaking were to stop repeating the command, or the listener were otherwise unable to hear the speaker, the listener would turn the lights on. Enter the third person who hears the repeated command and begins to replicating the command for the lights to stay off. Even if the first person stops talking, the listener is still hearing the command from the third person and therefore keeps the lights turned off.

A purpose-built circuit, or, for this discussion, a mass-produced circuit can be modified for the express purpose of activating an IED upon the disruption of the signal intended for its reception. For example, an RC car will drive in a forward direction as long as it receives the proper signal. Upon disruption of the signal it will cease forward movement. When applied to an IED, a relay, either electronic or electro-mechanical, would be placed within the circuit where a servo would normally be placed. Upon application of the signal, where a servo would normally be energized, the coil within a relay would instead be energized and open the normally-closed armature. At this point a second single pole-single throw (or similar) switch would be manually closed. This second switch would be referred to as a safety switch by the maker of the IED. Upon the loss of the signal, or upon the sufficient decay in the power source to the relay, the armature within the coil would return to its normally-closed position, completing another circuit, thereby permitting voltage, from either another power source or a built-in capacitor, to travel through the wires to an electric detonator causing a high-order detonation of the high explosive main charge. This armature might also, instead of causing the detonation of the IED, complete a circuit for a separate firing system to become active, such as a pressure mat. The pressure mat can be driven over or stepped upon without detonation of the IED as long as the proper signal is received or as long as the power source for the added relay contains sufficient power to hold the armature within the relay in an ‘open’ condition. Bt way of analogy, consider a person in the dark with a flashlight. The person holding the flashlight can only see a certain distance because of the amount of light being projected by the flashlight. However, another person can see the flashlight at a far greater distance. An actively transmitting IED as previously described will be detected at a distance far greater than what an active or reactive ECM system will be able to effectively suppress until within a relatively close proximity to the IED.

### SUMMARY OF THE INVENTION

It is, therefore, an object of the present invention to provide an apparatus and method of detecting and replicating IED transmissions without the high power requirements of the current jamming technology. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an illustration of a Radio Controlled Improvised Explosive Device (RCIED) and an associated triggerman with the targeted vehicle entering the danger zone.

FIG. 2 illustrates an RCIED in which the triggering signal has been identified and jammed by the vehicle-mounted electronic counter-measures (ECM).

FIG. 3. Representation of an RCIED that utilizes the jamming effect of the ECM to change from the state of unarmed to the state of armed. This could also be a representation of the present invention that has analyzed and is replicating the signal thereby preventing the state of the RCIED to change as it approaches the danger zone.

FIG. 4. Representation of the first vehicle passing information to a nearby vehicle and the second vehicle continues replicating the signal as it approaches the danger zone.

FIG. 5. Representation of two systems that incorporate the present invention being used to geo-locate the RCIED transmitter through resection in order to locate, identify and neutralize the IED. This process could be accomplished by a single system if needed.

FIG. 6. Representation of the logic/decision process of the present invention as incorporated into a reactive jamming system.

FIG. 7. Representation of the logic/decision process of the present invention as a stand-alone system.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

The primary embodiment of the invention includes a receiver for receiving RF transmissions of repetitious signals from a target transmitter, a micro-processor to determine the coding of signals and the generation of an identical signal, a transmitter that transmits the replicated signal to the receiver of the target transmitter, and a controlling micro-processor that controls and coordinates reception and transmission between multiple replication micro-processors. While the preferred embodiment of this invention is to be incorporated within existing or future reactive type jammers to prevent the reactive ECM system from defeating the replication signal generated by the invention, other embodiments of the present invention may act as a stand alone system. Some embodiments that are of a ‘stand alone’ nature may be equipped with a plurality of replication cards to replicate more than one signal. These replication cards may be controlled by a ‘Controller’ so that the resources of the invention are maximized against the total threat environment.

Embodiments of the invention shall utilize a GPS engine and shall contain software programming that shall contain a ‘template’ for when a threat area has been determined. For example, when a threat is detected and is being replicated, the replication shall continue until the limits of the ‘template’ have been reached as determined by the GPS engine. This template may be configurable by qualified persons familiar with the software interface. A further example of this ‘template’ might be a one kilometer distance in all directions from the point of first detection and replication. After the GPS engine has determined that the invention has traveled one kilometer it shall rescan for the threat and if the threat is still present the invention shall create another memory entry and shall continue replication of the threat signal for one more kilometer where the invention shall re-scan.

In various embodiments the invention may contain a plurality of similar microprocessor systems. Each microprocessor can be programmed to scan/replicate different portions of the RF spectrum or may be assigned to the same portion of the RF spectrum in an effort to replicate multiple signals. The existing threat and adjustment of this capability will be determined by qualified personnel. In other embodiments, the invention may be contained in a ruggedized and weather resistant housing for protection from extreme temperatures, dust, rain and other hazards that may be encountered in operational environments. Still other embodiments may be utilized in static locations i.e. installation entry control points. This will prevent certain IED fuzing systems that are in mobile configuration i.e. Vehicle-Borne IED (VBIED) from properly functioning.

Other embodiments of the present invention may contain additional antennae and associated circuitry that will enable the system to determine the strength of a signal that has been identified as a threat to be replicated. This signal strength and directional information will enable qualified Explosive Ordnance Disposal (EOD) personnel to locate and render safe any potential hazards that may exist. Bearing in mind that this information will lead EOD personnel to the transmitter and not the intended receiver. This capability may also include graphic representation through the use of approved mapping software in use by military elements.

The present invention may contain ability to transmit geographic data as well as specific information pertaining to any threat signal identified. This warning may also be distributed through an electronic notification system commonly known as ‘Blue Force Tracker’. In this type of notification geographic data as well as the time based on the GPS engine shall be distributed to other elements that are out of range of the original specified threat notification system. Informed of the ‘threat area’ other elements may elect to divert their planned travel paths and avoid the ‘threat area’ altogether. Should a fault occur within the electronics or a repetitious signal that the invention cannot replicate be detected, an entry into the memory module will be entered and the signal will not be replicated. However, through notification to the Control Module, this frequency will not be jammed. This will prevent the interruption of the repetitious signal thereby preventing the IED from proper operation.

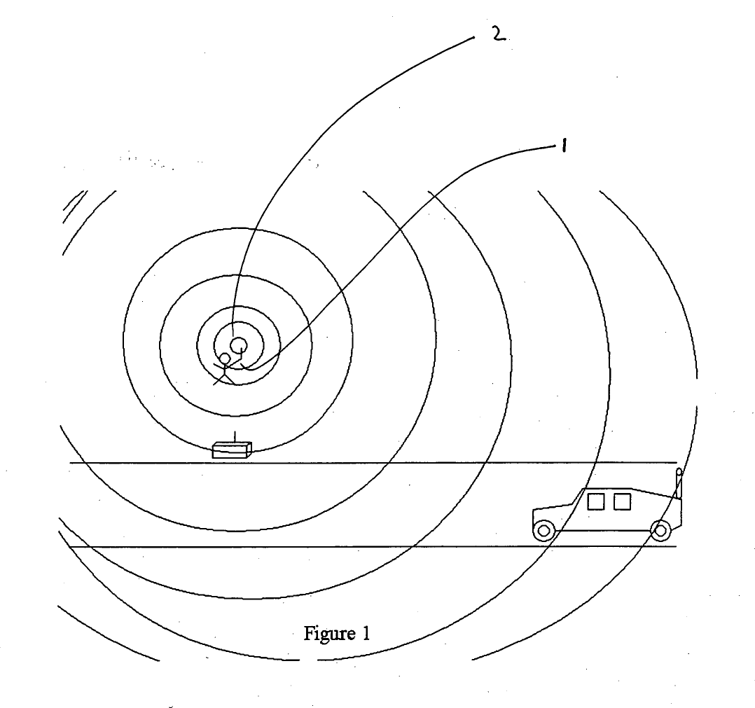

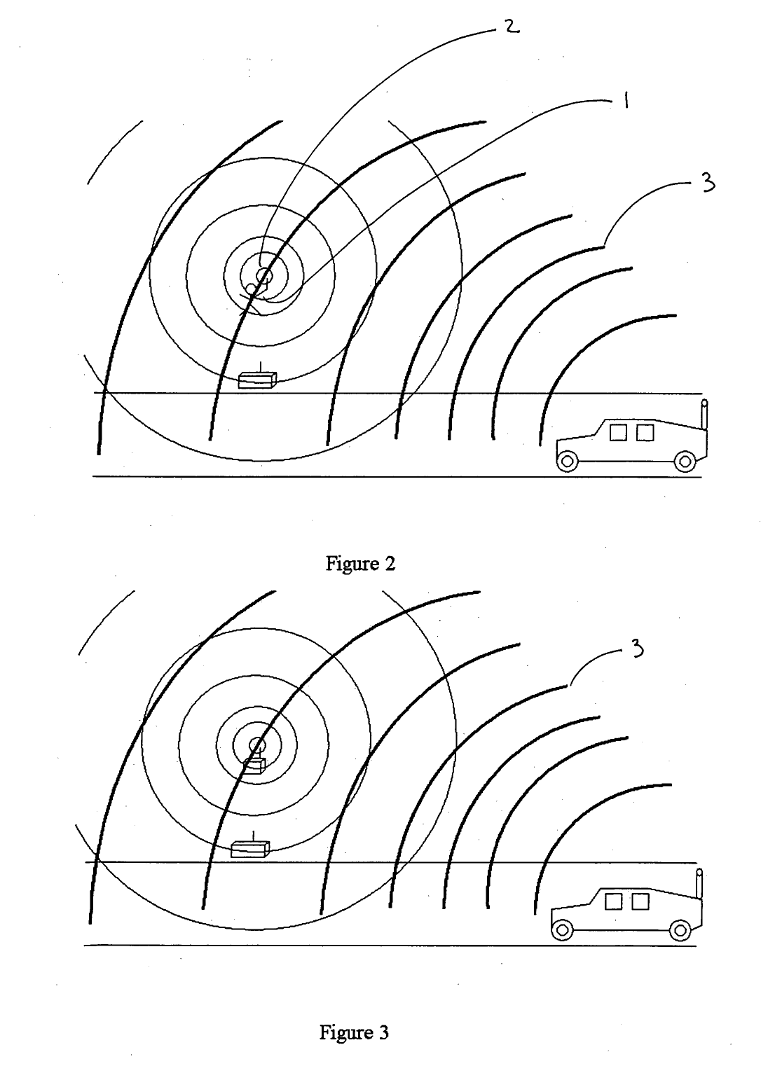

The preferred embodiment of the present invention is illustrated in FIGS. 1 thru 5 which represent a vehicle mounted apparatus. In FIG. 1 the RCIED [4] is armed, disarmed or functioned by a triggerman [1] using a form of radio frequency transmission device [2]. This is the current manner of RCIED control. This is also the manner in which conventional Electronic Counter-Measures are designed to disrupt as represented by FIG. 2. FIG. 3 represents an RCIED that utilizes repetitive signal technology [3]. When conventional ECM systems encounter this signal the programming is to commence emitting a disruptive RF signal. When this happens, the receiver of the signal, no longer receiving the signal, follows its programming and arms itself. It then waits for the final action required for detonation.

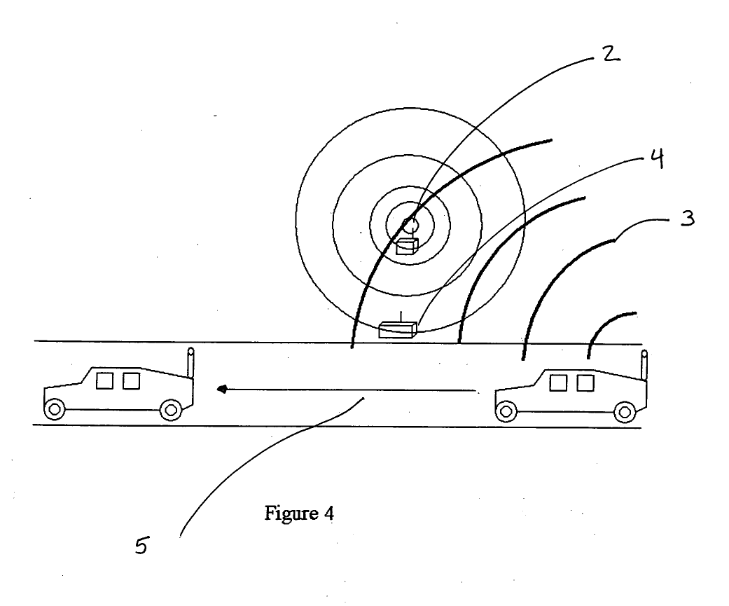

The preferred embodiment of the present invention is also represented by FIG. 3. The preferred embodiment will detect the signal, determine if the signal is in fact repetitious in nature, determine the position of the invention, through the GPS engine, communicate, through the systems controlling software, not to interfere with the frequency that the signal is being transmitted, and begin transmitting on the same frequency that the signal is being transmitted, a replication of the targeted signal [3]. The controlling software will create a record of the pertinent information for storage within the hardware. The system will also transmit this replication information on a discreet frequency to other like systems that are within reception range of the replicated signal. This is illustrated by FIG. 4. After a preset distance has been traveled [5], as determined by the GPS engine, the present invention will cease replication of the signal. It will then scan the frequency for the formerly replicated signal in order to determine whether or not the signal is still present. If the signal is still and determined to still be a threat the present invention will create another entry into memory and continue replication of the signal until the next preset is reached. At this stage one manner that a detected signal can be determined to no longer present a threat is upon receipt of a message on the discreet frequency that the signal is being replicated by another like invention.

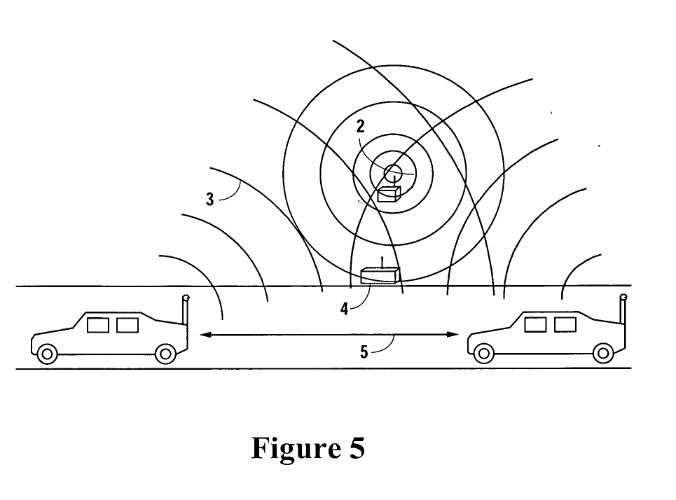

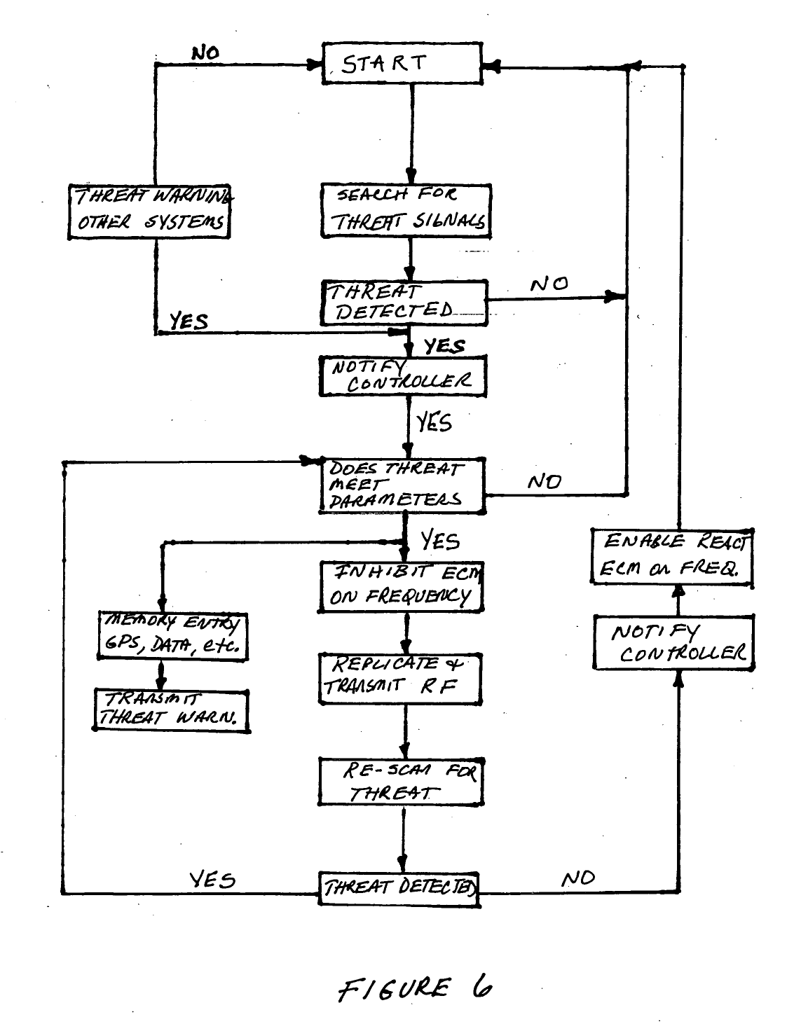

As depicted in FIG. 5, the present invention may be utilized by qualified personnel to locate any potential IED that is transmitting a repetitious signal. The manner in which this is accomplished by a single system involves the use of direction finding equipment that can be incorporated within the present invention or as a separate system. The use of a single vehicle will require the direction finding of the signal from multiple locations. The azimuth from the present invention to the transmitter can be determined and plotted using manual techniques or through the use of mapping software. The use of a single system will be a longer and more involved process. The use of multiple systems, each at a different location, can determine the approximate location of the targeted transmitter. Azimuths from each system can be communicated, through the operator, to the party responsible for the mapping effort. Once an approximate location has been determined, proper steps can be taken to identify the transmitter, locate and identify the receiver and render the IED harmless. At the appropriate time qualified personnel may download information recorded within the system for analytical review. The present invention can be incorporated into existing reactive-style ECM systems preventing frequency fratricide wherein the reactive ECM system begins jamming the replicated signal from the present invention.

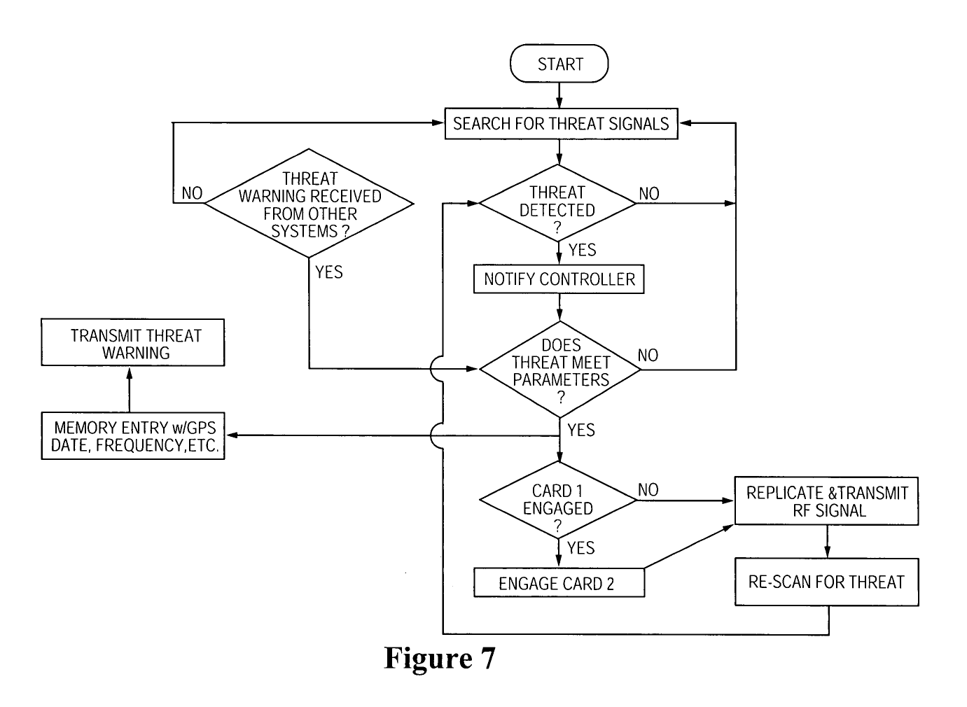

FIG. 6 illustrates the logic/decision process of the present invention as incorporated into a reactive jamming system while FIG. 7 depicts the logic/decision process of the present invention as a stand-alone system.

1. An apparatus for listening to radio transmissions and identifying repetitious signals that might potentially be a communication between and IED transmitter and an IED firing system wherein once detected, said apparatus transmits a signal that replicates said repetitious signal sufficient to control the IED firing system.

2. An apparatus for listening to radio transmissions and identifying repetitious signals that might potentially be a communication between an IED transmitter and an IED firing system wherein once detected, said apparatus transmits a signal that replicates said repetitious signal sufficient to control the IED firing system comprising a receiver for receiving RF transmissions of repetitious signals from the IED, a target transmitter, a micro processor to determine the coding of the repetitious signals and the generation of an identical signal, a transmitter that transmits the replicated signal to the IED receiver, and a controlling micro processor that controls and coordinates reception and transmission.

3. The apparatus of claim 2 further comprising a GPS engine.

4. The apparatus of claim 2 further comprising a means to transmit geographic as well as specific information pertaining to the repetitious signals detected.

5. The apparatus of claim 2 wherein said apparatus is located in a vehicle.

6. A method for detecting and jamming a potential improvised explosive device comprising the steps of:
searching for threat signals and if present;
transmitting a signal that replicates the threat signal detected sufficient to control the improvised explosive device.

7. The method of claim 6 further comprising the step of providing a means for storage of all data associated with the threat signal.

8. The method of claim 6 further comprising the step of transmitting geographic as well as specific information relating to the threat detected.

9. The method of claim 6 further comprising the step of inhibiting reactive ECM.
